(19) United States
(12) Patent Application Publication
(10) Pub. No.: US 2024/0234933 A9
(43) Pub. Date: Jul. 11, 2024

(54) BATTERY PACK VENTING WITH REACTION SUPPRESSION

(71) Applicant: Dana Automotive Systems Group, LLC, Maumee, OH (US)

(72) Inventors: Louisa OUALIM, Royal Oak, MI (US); Christopher M. COOK, McKenzie, TN (US); Samuel Wesley COX, Paris, TN (US)

(21) Appl. No.: 18/473,575

(22) Filed: Sep. 25, 2023

Related U.S. Application Data
(60) Provisional application No. 63/380,199, filed on Oct. 19, 2022.

(51) Int. Cl. H01M 50/358; H01M 10/42; H01M 10/48; H01M 50/209; H01M 50/317; H01M 50/375; H01M 50/383

(52) U.S. Cl. CPC H01M 50/358; H01M 10/425; H01M 10/486; H01M 50/209; H01M 50/317; H01M 50/375; H01M 50/383; H01M 2010/4271

(57) ABSTRACT

Methods and systems are provided for a battery system which comprises a plurality of battery cells housed inside a battery enclosure of a battery pack, a venting system, and a suppressing agent. The venting system comprises a dual-staged venting valve that equalizes pressure during normal operation of the battery system and a vent valve that opens to relieve pressure during a high pressure or temperature event. The suppressing agent is released into the enclosure of the battery pack to reduce further reactions by removing or limiting oxidants within the battery pack. A solenoid is coupled to the dual-staged venting valve and seals the dual-staged venting valve following release of the suppressing agent, allowing for the suppressing agent to remain in the enclosure for a longer period of time in order to provide increased mitigation of future thermal events in the battery enclosure.

### CROSS REFERENCE TO RELATED APPLICATIONS

The present application claims priority to U.S. Provisional Application No. 63/380,199, entitled “BATTERY PACK VENTING WITH REACTION SUPPRESSION”, and filed on Oct. 19, 2022. The entire contents of the above-listed application are hereby incorporated by reference for all purposes.

### TECHNICAL FIELD

The present description relates generally to a reaction suppression system, more specifically a battery pack of a rechargeable electric vehicle comprising a reaction suppression system.

### BACKGROUND AND SUMMARY

A battery assembly, including a battery, may be installed in an automotive vehicle for assisting engine start and powering other vehicle systems. The battery may be enclosed in a cover to shield the battery from contact with external objects, provide a thermal barrier to inhibit heat conduction from the battery to surrounding components, and maintain the position of the battery relative to the vehicle. The battery enclosure thus provides a barrier between the battery and other objects and reduces a likelihood of combustion arising from overheating or puncture. Rechargeable battery packs, such as lithium-ion battery packs, are widely used in electric vehicles to supply one or more electric motor(s) with power. Lithium-ion batteries are an example of high energy density batteries. Upon charging and discharging of such a battery pack, heat may be generated inside battery cells of the battery pack thereby affecting temperature of the pack.

In some examples, such as an electric vehicle or a hybrid electric vehicle operating in all-electric mode, propulsion and operation of other vehicle systems exclusively relies on electric power. In order to improve battery performance, battery temperature control may be provided by a thermal management system. Battery cells within an enclosure of a battery pack are prone to exothermic reactions caused by shorts or faults within the cell that lead to high pressure and temperature events which may cause degradation of the battery cell, the enclosure, and the battery pack. In addition to providing battery packs with such thermal management systems, various systems may be provided to remove or limit oxidants around the battery cells to reduce possibility of additional exothermic reactions that can further increase temperature and/or battery degradation.

However, the inventors herein have recognized potential issues with thermal management systems. As one example, the risk of degradation remains in thermal management systems that employ only a cooling system or a venting strategy but are unable to reduce oxidants within the enclosure produced by exothermic reactions. A mechanism is needed to rapidly dispense a suppressing agent inside the pack to slow an exothermic reaction from causing further degradation to the battery.

The inventors herein have recognized the aforementioned challenges and developed a reaction suppression system to at least partially address these challenges. In an example, a battery pack is disclosed that provides a venting system that is designed and controlled in tandem with the release of a suppressing agent (SA) into the battery pack. The venting system includes a first vent valve that opens first to relieve pressure/temperature and then the vent closes via a solenoid to seal the enclosure during release of the SA. Sealing the enclosure during release of the SA retains more of the SA inside the pack over a longer period of time, which may provide increased mitigation of future thermal events in the battery enclosure.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

The above, as well as other advantages of the present disclosure, will become readily apparent to those skilled in the art from the following detailed description when considered in light of the accompanying drawings in which:

FIG. 1 shows an example of an at least partially electrified vehicle.

FIG. 2 shows a perspective view of an example of a battery pack with a reaction suppression system.

FIG. 3A shows an example of a dual-staged venting valve in a closed position.

FIG. 3B shows an example of the dual-staged venting valve in an open position.

FIG. 4 shows timing diagrams of an operating sequence for a reaction suppression system with active venting and sealing strategy within a battery pack.

FIG. 5 is a flowchart of a method for operating the reaction suppression system of the battery pack.

### DETAILED DESCRIPTION

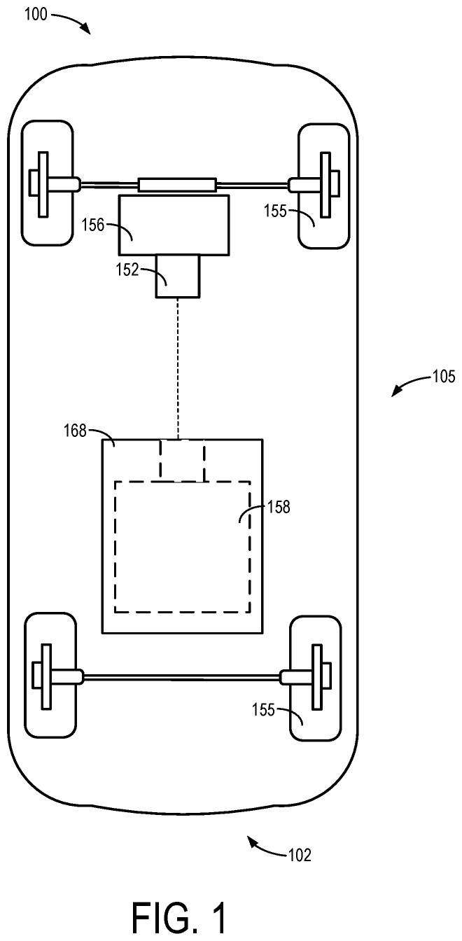

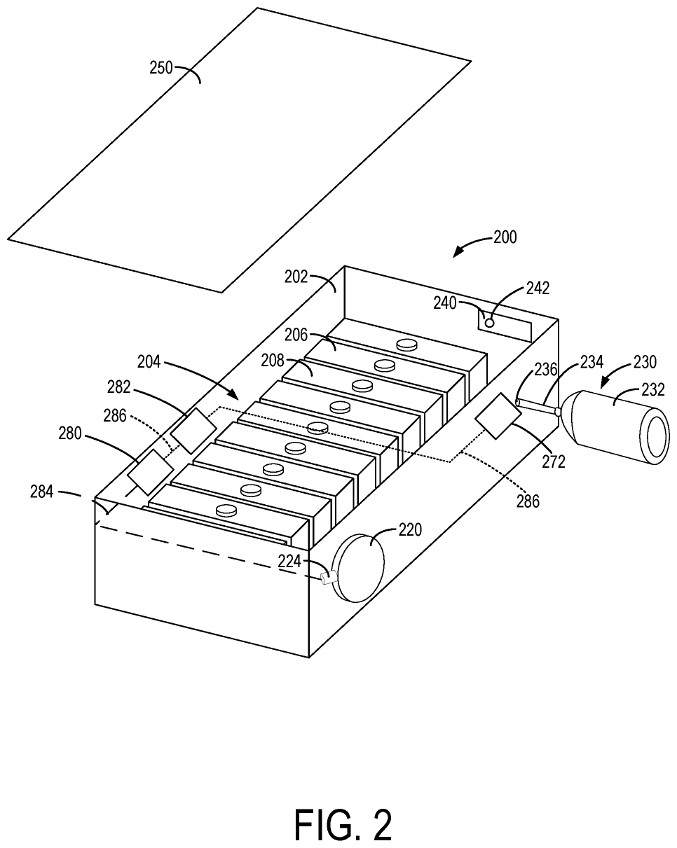

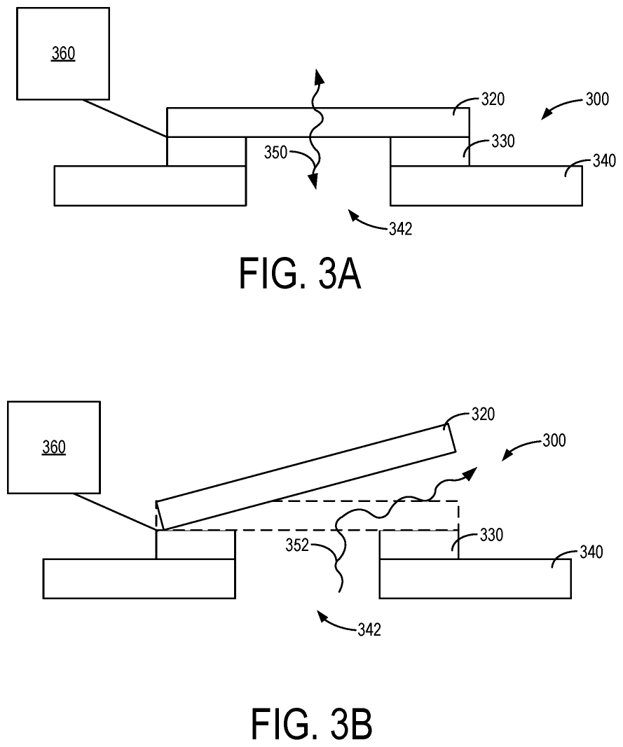

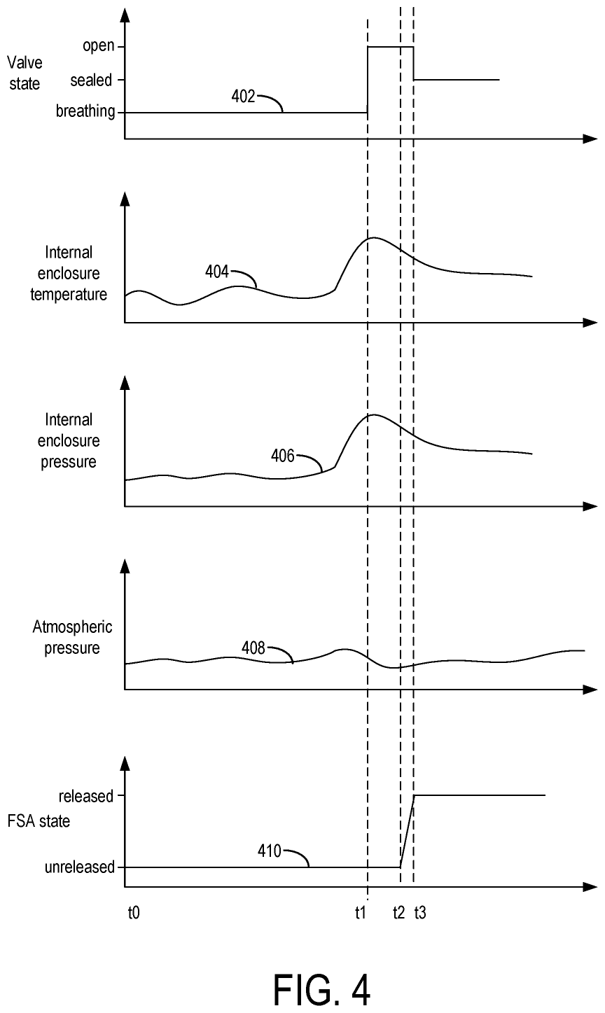

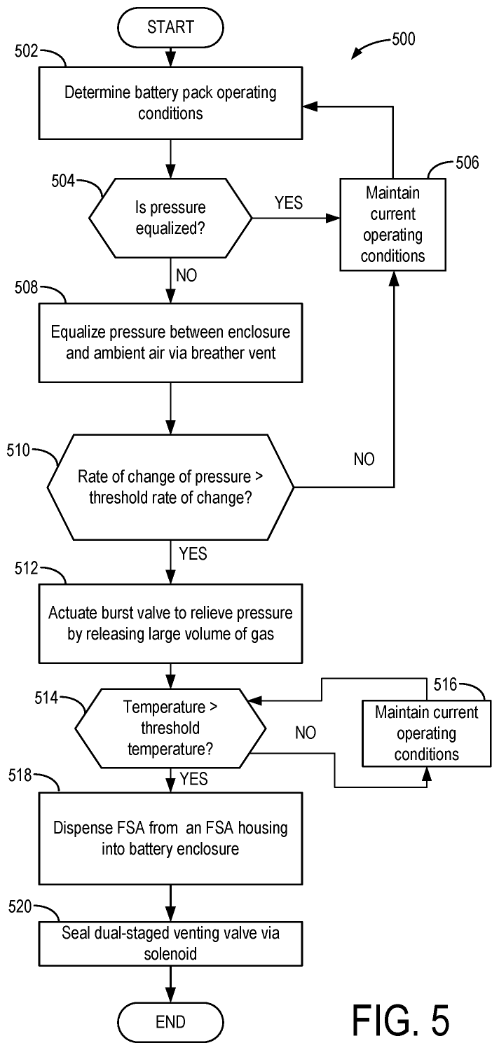

The following description relates to systems and methods for a battery pack system of an electric vehicle with an internal reaction suppression system including an active venting and sealing strategy. An example of a vehicle configured with an electrified vehicle drive train system, including a battery housed in an enclosure, is shown in FIG. 1. The battery system may comprise at least one battery pack, each of which comprises an enclosure comprising a plurality of battery cells, a monitoring system, a battery pack venting system, and a suppressing agent (SA), as shown in FIG. 2. The venting system may comprise a dual-staged venting valve and a solenoid, as shown in FIGS. 3A and 3B. A use-case operating sequence of the venting and sealing strategy of the battery pack and release of the SA in a high pressure or temperature event is depicted in FIG. 4. A method for pressure equalization and venting and reaction suppression during a high pressure or temperature event is depicted in FIG. 5.

In one example, the disclosure provides support for a battery system including a battery pack venting system and a suppressing agent (SA). The battery pack venting system may include one or more valves. The one or more valves may be configured as a dual-staged venting valve which comprises a breather vent to equalize pressure between the enclosure and an external environment during normal operations and also comprises a first vent valve to relieve pressure and heat in the event of an exothermic reaction within the battery cell. The dual-staged venting valve may be configured to selectively vent via either the breather vent or the first vent valve responsive to an operating condition of the battery system.

An SA may be housed external to or within the enclosure and may be released into the enclosure during a thermal event in which temperature and/or pressure rises. A solenoid may be coupled to the dual-staged venting valve in order to seal the valve after the first vent valve has been actuated. The solenoid may be configured to be triggered to seal the dual-staged venting valve by the release of the SA. In this way, the SA that is released into the enclosure may be kept inside the enclosure long enough to increase mitigation of further thermal events in the enclosure of the battery pack.

FIGS. 1-3 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation).

Turning now to FIG. 1, an example vehicle 105 is shown. In some examples, vehicle 105 may be a hybrid vehicle with multiple sources of torque available to one or more vehicle wheels 155. In other examples, vehicle 105 may be an all-electric vehicle, powered exclusively by an energy storage device such as a battery assembly, herein referred to as a battery 158. In the example shown, vehicle 105 includes an electric machine 152 which may be a motor or a motor/generator. Electric machine 152 receives electrical power from the battery 158 which is converted to rotational energy, e.g., torque, at a transmission 156. The torque is delivered to vehicle wheels 155. Electric machine 152 may also be operated as a generator to provide electrical power to charge battery 158, for example, during a braking operation.

While electric machine 152 is shown providing rotational energy to the vehicle wheels 155 proximate to a front end 100 of vehicle 105, e.g., at front wheels of the vehicle, via the transmission 156, it will be appreciated that the transmission 156 may be alternatively arranged at rear wheels of vehicle 105, e.g., vehicle wheels 155 proximate to a rear end 102 of the vehicle, and energy from the electric machine 152 transmitted thereto. Alternatively, the transmission 156 may be arranged toward the front end, but transmit mechanical energy from the electric machine 152 to the rear wheels of vehicle 105 via a drive shaft and/or a differential. Furthermore, in other examples, each of the front wheels and the rear wheels may be coupled to individual transmissions, such as when vehicle 105 is configured with all-wheel drive.

In the depicted example, the battery 158 may be installed in a rear region of the vehicle, e.g., between the vehicle wheels 155 and closer to the rear end 102 of the vehicle 105 than the front end 100. In one example, the battery 158 may be positioned below rear passenger seats of the vehicle. In other examples, the battery 158 may be located in a floor of a rear compartment of the vehicle or may be integrated into a vehicle chassis. The battery 158 may be secured within a battery enclosure 168 formed of a rigid material, such as a composite, e.g., a polymer composite. The battery enclosure 168 may entirely enclose the battery 158, providing a barrier between the battery 158 and external components to the battery enclosure 168. The battery enclosure 168 may absorb vibrations from the vehicle that would otherwise be imparted to the battery 158. In order to install the battery 158 within the battery enclosure 168, the enclosure may be comprised of two parts that are assembled around the battery and secured to one another.

The battery assembly (e.g., the battery 158) may be a single battery or may include a plurality of cells electrically coupled to one another. A quantity of the plurality of cells may determine a capacity of the battery 158. The battery 158 may be configured with a high power-to-weight ratio, high specific energy, and high energy density to provide power over long periods of time. Examples of battery types which may be used in vehicle 105 include lithium-ion, lithium polymer, lead-acid, nickel-cadmium, and nick-metal hydride batteries, amongst others. The battery 158 may be a rechargeable battery, such as a battery formed of lithium-ion cells. When configured as a rechargeable battery, the battery 158 may be recharged by regenerative braking operations or an external power source. Battery performance and life may depend on the applied load (and therefore on the charge/discharge rate), as well as operating conditions (such as temperature). The battery 158 may work efficiently over a range of discharge rates (e.g., C/8-2C), within a target range of operating temperatures (typically from 20° C. to 45° C.), and at relatively uniform temperature (e.g., temperature uniformity of less than 5° C.).

Temperature within the battery 158 may rise to a level that is not sustainable for operation of the battery 158 as a result of a reaction within a battery cell of the battery 158. An active venting and sealing strategy herein described may be implemented in order to mitigate temperature rise during such a thermal event in conjunction with an SA that may be dispersed throughout the enclosure of the battery 158.

Turning now to FIG. 2, a schematic structural diagram of a battery pack 200 is shown. Battery pack 200 may be at least part of the battery 158 depicted in FIG. 1. Battery pack 200 comprises a battery enclosure 202, a plurality of battery cells 204, a dual-staged venting valve 220 with a solenoid 224, a monitoring system 240, an independent power supply 280, and an SA enclosure 230. In some examples, the plurality of battery cells 204 may be configured into multiple battery modules housed within an enclosure. The battery pack 200 is depicted in FIG. 2 in a perspective view with a lid 250 uncoupled from the battery enclosure 202. In some examples, the lid 250 may be coupled to the battery enclosure 202 such that the battery enclosure 202 is sealed off from a surrounding environment with the exception of integrated valves (e.g., the dual-staged venting valve 220).

The plurality of battery cells 204 may be housed within the battery enclosure 202 of the battery pack 200. The plurality of battery cells 204 may comprise multiple battery cells, such as a battery cell 206 and a battery cell 208 electrically coupled together. A battery cell is a basic unit of a battery, such as a lithium ion battery, that exerts electric energy by charging and discharging. The energy from the battery cell(s) may then be converted and further used to power what the battery is connected to, in this case a vehicle and vehicle wheels.

Battery cells, such as battery cell 206 and battery cell 208 may be prone to exothermic reactions in the event of a fault or a short within the battery cell that cause a rise in the temperature within the battery enclosure 202. As discussed, rise in temperature within the battery enclosure 202 may result in degradation of the battery pack 200.

Pressure, which is directly proportional to temperature within a sealed container, may increase along with temperature during an exothermic reaction. The rate of increase of pressure and temperature may not be exactly equal given that the battery enclosure 202 of the battery pack 200 is, in some examples, equipped with a vent, such as dual-staged venting valve 220, that equalizes pressure between the battery enclosure 202 and the external environment. The dual-staged venting valve in the breathing stage may not be able to maintain equalization with rapidly increasing pressure that occurs during a thermal event in which temperature rapidly increases, and therefore the pressure within the battery enclosure 202 may increase similar to the temperature increase within the enclosure in such an event, such that pressure and temperature are directly proportional (in a sealed environment). If pressure is reduced, temperature may also be reduced. Reducing the temperature may slow the exothermic reaction, thereby slowing the rate of rise of temperature.

The SA enclosure 230 is depicted in FIG. 2 outside of the battery enclosure 202 of the battery pack 200. In some examples, the SA enclosure 230 may be alternatively positioned within the battery enclosure 202 of the battery pack 200. The SA enclosure 230 comprises an SA housing 232 that houses a suppressing agent. The SA housing 232 may be a pressurized canister or other suitable housing. The suppressing agent may be a gas agent, liquid agent, or solid agent (e.g., a powder). Examples of the SA includes . . . [give example compositions] The SA enclosure 230 further comprises piping 234 and valve 236. The suppressing agent, when dispensed, may flow through the piping 234. The valve 236 may be in a closed position when the SA is not yet dispensed (e.g., during normal operation of a vehicle such as vehicle 105), and upon actuation, the valve 236 may open in order to dispense the SA from the piping 234 into the battery enclosure 202 of the battery pack 200. The valve 236 may be a mechanically activated valve that actuates upon pressure in the battery enclosure 202 reaching a threshold value. Alternatively, valve 236 may be an electrically activated valve receiving command signals from an electronic controller with instructions programmed therein to actuate the valve upon selected pressure and/or temperature conditions, and further based on various additional parameters.

The dual-staged venting valve 220 may be positioned in fluid connection with the enclosure 202. The dual-staged venting valve 220 may be comprised of multiple components configured with a plurality of stages. In a first stage, the dual-staged venting valve 220 may equalize pressure of the battery pack 200 during normal operation of a vehicle. The dual-staged venting valve 220 may be configured to, in a second stage, open to relieve pressure by allowing escape of an unrestricted flow of gas (relatively large compared to the amount of gas that escapes in the first stage of the dual-staged venting valve 220). Further details regarding the configuration of the dual-staged venting valve 220 are described with respect to FIGS. 3A and 3B.

In an embodiment of the present disclosure, the dual-staged venting valve 220 is configured to be actuated to transition from the first stage to the second stage when air pressure or temperature rapidly rises within the battery enclosure 202. The monitoring system 240 may comprise at least one sensor 242 that senses pressure or temperature within the battery pack 200. In some embodiments, when the sensor 242 of the monitoring system 240 senses a pressure or temperature above a threshold, the sensor may send information to the circuitry 282 to actuate the dual-staged venting valve 220 to open. Alternatively, in other embodiments, when the sensor 242 of the monitoring system 240 senses a rate of change above a threshold, the sensor may send information to the circuitry 282 to actuate the dual-staged venting valve 220 to open. Thus, when an exothermic reaction occurs in the battery pack 200, combustible gas generated by the reaction of a battery cell (e.g., battery cell 206) in the battery enclosure 202 may be discharged from the battery enclosure 202 to the external environment. This release of gas may reduce the pressure within the battery enclosure 202 and may therefore reduce the temperature within the battery enclosure 202, slowing the exothermic reaction.

The dual-staged venting valve 220 may be coupled to the solenoid 224. The solenoid 224 may be configured to close (e.g., seal) the dual-staged venting valve 220 after the dual-staged venting valve 220 has opened to relieve pressure from the battery enclosure 202 of the battery pack 200. The solenoid 224 may be triggered to close the dual-staged venting valve 220 by the release of the SA from the SA housing 232. The solenoid may be connected to an independent power supply 280 and circuitry 282 via at least an electrical coupling. The independent power supply 280 may be connected to the circuitry 282 via a communicative coupling. A sensor 272 may detect when SA is released via the opening of the valve 236. The sensor may be communicatively coupled to the circuitry 282, such that the circuitry may send a signal to the power supply to actuate the solenoid 224 to close the duel-stage venting valve. An electrical coupling may be represented by a plurality of dashed lines 284. A communicative coupling may be represented by a solid line 286. Following the solenoid 224 sealing the dual-staged venting valve 220, the dual-staged venting valve 220 is in a third stage.

The battery pack 200 may comprise the independent power supply 280 housed within the battery enclosure 202. Alternatively, the independent power supply 280 may be coupled to but not housed within the battery enclosure 202. The independent power supply 280 may be coupled to the dual-staged venting valve 220 and the solenoid 224 so that the independent power supply 280 may supply power to the dual-staged venting valve 220 and the solenoid 224. The independent power supply 280 may be coupled to circuitry 282 (e.g., a microprocessor). The circuitry 282 may be housed within the battery enclosure 202 (as depicted in FIG. 2) or housed external to the battery enclosure 202. The circuitry 282 may receive information from the monitoring system 240. Based on the information from the monitoring system 240, the circuitry 282 may actuate components such as the solenoid 224 or the dual-staged venting valve 220. In some examples, the independent power supply 280 may be powered off and may not provide power to the solenoid 224 and the dual-staged venting valve 220. Thus, during conditions in which no power is provided to the dual-staged venting valve 220, the dual-staged venting valve 220 may not equalize pressure or open, meaning without power the dual-staged venting valve 220 is in a sealed position, e.g., the third stage. The solenoid 224, without power from the independent power supply 280, may not actuate to close or open the dual-staged venting valve 220. In the event of power loss to the independent power supply 280, such as during a mechanical injury to the battery pack, the dual-staged venting valve 220 may be in a closed position and therefore the SA may be released into the battery enclosure 202 without escaping to the external environment.

In some embodiments, the SA housing 232, the SA valve 236, and the monitoring system 240 (including the sensor 242) may be connected to a different power supply (e.g., the battery to which it is coupled or another power source) insofar that the SA may still be released from the SA housing 232 in the event of power loss to the independent power supply 280.

Referring to FIG. 3A-3B, schematic drawings of a dual-staged venting valve 300 are shown. Dual-staged venting valve 300 may be the dual-staged venting valve 220 depicted in FIG. 2. In FIG. 3A, the dual-staged venting valve 300 is depicted in a closed position. FIG. 3A depicts the first stage of operation of a dual-staged venting valve, such as dual-staged venting valve 220 depicted in FIG. 2. In FIG. 3B, the dual-staged venting valve 300 is depicted in an open position. FIG. 3B depicts the second stage of operation of a dual-staged venting valve, such as dual-staged venting valve 220 depicted in FIG. 2.

A dual-staged venting valve, such as dual-staged venting valve 220 depicted in FIG. 2, may combine the function of a protective breather vent with the functionality of a one-way relief valve. The protective breather vent component may allow for venting of an enclosure (e.g., battery enclosure 202 depicted in FIG. 2) during normal operating conditions of an electric vehicle (e.g., vehicle 105 depicted in FIG. 1). If there is a high pressure or high temperature event in the enclosure, which may cause release of gas and/or a relatively large temperature/pressure increase in a relatively short amount of time (e.g., as compared to venting), the dual-staged venting valve may open to allow higher unrestricted airflow out of the enclosure to avoid overpressure in the enclosure and decrease the temperature in the enclosure that could otherwise cause damage to internal components of the enclosure (e.g., battery cells).

In some embodiments, the dual-staged venting valve 300 may comprise a breather vent 320 and a coupling structure 330. The breather vent 320 may generally be positioned in fluid connection with an opening 342 in a battery enclosure 340 of a battery pack (e.g., battery pack 200 of FIG. 2), thereby defining an internal environment within the battery enclosure 340 (e.g., an interior of the battery enclosure 340) and an external environment outside the battery enclosure 340. The dual-staged venting valve 300 may be positioned in fluid connection with the battery enclosure 340 insofar that the dual-staged venting valve 300 fluidically couples the interior of the battery enclosure 340 to the external environment. The breather vent 320 may be configured to allow gases to pass into and out of the battery enclosure 340 from the environment outside the battery enclosure 340 by flowing through breather vent 320. A flow path 350 depicted in FIG. 3A demonstrates the two-way flow of gases into and out of the battery enclosure 340 through the breather vent 320. In some embodiments, the breather vent 320 is configured to prevent particles (e.g., debris) and/or liquids (e.g., water) from entering into the battery enclosure 340. In various embodiments, the breather vent 320 incorporates a breathable membrane that allows the passage of gases but not larger molecules like water. In other various embodiment, the breather vent 320 incorporates a breathable membrane that allows the passage of gasses, and is composed of a hydrophobic material to prevent certain liquids, such as water, from passing through the membrane. The breathable membrane may allow molecules of gas that are larger molecules than water, such as a carbon dioxide, to pass through the breathable membrane. In other various embodiment, the breather vent 320 incorporates a breathable membrane that allows the passage of gasses, but incorporates a hydrophilic or adhesive component to wick away and prevent certain liquids, such as water, from moving through the membrane. The breathable membrane may allow molecules of gas that are larger molecules than water, such as a carbon dioxide, to pass through the breathable membrane.

The coupling structure 330 may be configured to couple the breather vent 320 to the enclosure 340 under normal pressure conditions. When the pressure inside the enclosure 340 rises rapidly, the coupling structure 330 may release from the battery enclosure 340 upon actuation to allow gas escaping from the battery enclosure 340 to bypass the breather vent 320, as depicted in FIG. 3B. Flow path 352 depicted in FIG. 3B demonstrates the unrestricted one-way flow path of gases out of the battery enclosure 340 after the first vent valve component of the dual-staged venting valve 300 has opened during a high pressure event. The coupling structure 330 may have a mechanism that is pressure sensitive.

A solenoid 360 may be connected to the dual-staged venting valve 300. When released, the coupling structure 330 may maintain contact with the battery enclosure 340 so that the solenoid 360, when actuated, may seal (e.g., close) the coupling structure 330 to the battery enclosure 340. When the solenoid 360 seals the dual-staged venting valve 300, the interior of the battery enclosure 340 is sealed off from the external environment. The dual-staged venting valve 300 may remain sealed for at least a duration after the release of the SA in order to retain the SA within the battery enclosure 340.

Referring now to FIG. 4, a use-case vehicle operating sequence, specifically an operating sequence of the reaction suppressing system including the active venting and sealing strategy, is shown. The operating sequence of FIG. 4 may be provided via the system of FIGS. 1-3 in cooperation with the methods of FIG. 5. The vertical lines at times t0-t3 represent times of interest during the operating sequence. The plots are time aligned. The horizontal axis of each plot represents time and time increases from the left side of the plot to the right side of each plot.

The first plot from the top of FIG. 4 is a plot of a state of a dual-staged venting valve of a battery pack versus time. Three states available for the dual-staged venting valve are breathing, sealed, and open. The vertical axis represents the dual-staged venting valve state. When trace 402 is at a higher level that is near the vertical axis arrow, the dual-staged venting valve is in the open state. When trace 402 is at a lower level that is near the horizontal axis, the dual-staged venting valve is in the breathing state. When trace 402 is between the higher level and the lower level (e.g., in the middle of the vertical axis), the dual-staged venting valve is in the sealed state. Trace 402 represents the state of the dual-staged venting valve. The dual-staged venting valve state may be asserted via an actuator of a circuit connected to a power supply triggered by a sensor of a monitoring system.

The second plot from the top of FIG. 4 is a plot of internal temperature within an enclosure of the battery pack versus time. The vertical axis represents the temperature within an enclosure and temperature increases from the bottom of the plot to the top of the plot. Trace 404 represents the temperature within the enclosure of the battery pack.

The third plot from the top of FIG. 4 is a plot of internal pressure within the enclosure of the battery pack versus time. The vertical axis represents the internal pressure within the enclosure and pressure increases from the bottom of the plot the top of the plot. Trace 406 represents the internal pressure within the enclosure of the battery pack.

The fourth plot from the top of FIG. 4 is a plot of atmospheric pressure versus time. The vertical axis represents the atmospheric pressure and the atmospheric pressure increases from the bottom of the plot to the top of the plot. Trace 408 represents the atmospheric pressure external to the enclosure of the battery pack.

The fifth plot from the top of FIG. 4 is a plot of the state of a suppressing agent (SA) versus time. The vertical axis represents the SA state and the SA is released when trace 410 is at a higher level that is near the vertical axis arrow. The SA is not released when trace 410 is at a lower level that is near the horizontal axis. Trace 410 represents the SA state.

At time t0, the dual-staged venting valve is in the breathing state and the SA is unreleased. Time t0 represents a normal operating state of a vehicle wherein a dual-staged venting valve is equalizing pressure in the breathing state and the FSA is unreleased (e.g., contained within an enclosure). At time t0, the internal pressure within the enclosure matches the atmospheric pressure external to the enclosure because the breather vent is equalizing the pressure between the two environments.

At time t1, the dual-staged venting valve transitions from the breathing state to the open state. The internal temperature of the enclosure is near its highest point, having risen quickly just before time t1. The internal pressure within the enclosure is also near its highest point, having risen quickly just before time t1. The rapid rise in pressure and temperature indicates a thermal event or exothermic reaction. The internal pressure within the enclosure no longer matches the atmospheric pressure external to the enclosure as the dual-staged venting valve, just prior to time t1, is not able to equalize the pressure during such a reaction or event. At time t1, the atmospheric pressure is independent of the internal pressure within the enclosure. The temperature within the enclosure is independent of the internal pressure and atmospheric pressure. At time t1, the SA is still unreleased.

At time t2, the SA begins to be released via a valve of an enclosure in which the SA is housed within being opened. The internal temperature within the enclosure and the internal pressure within the enclosure are both lower than their respective highest points, as the opening of the dual-staged venting valve at time t1 allowed for decrease of pressure and temperature within the enclosure. The internal pressure and the internal temperature are dependent on each other. The atmospheric pressure is independent of the internal pressure within the enclosure. The dual-staged venting valve is in the open state at time t2 when the SA first begins to be released. The SA transitions from an unreleased state to a released state in between times t2 and t3.

At time t3, the dual-staged venting valve transitions from the open state to the sealed state. The SA is fully in the released state at time t3. The release of the SA between time t2 and time t3 may trigger a solenoid connected to the dual-staged venting valve to seal the dual-staged venting valve at time t3. The pressure within the enclosure and the temperature within the enclosure continue to be dependent on each other. The atmospheric pressure is independent of the pressure within the enclosure.

In this way, an exothermic reaction within a battery pack may be slowed by way of relieving pressure via an open dual-staged venting valve and oxidants resulted from the exothermic reaction may be removed or deactivated by the release of a suppressing agent into a battery enclosure. The dual-staged venting valve may be sealed following the release of the suppressing agent in order to keep the SA within the enclosure as long as possible in order to increase mitigation of future thermal events in the enclosure.

Referring now to FIG. 5, a method 500 for a reaction suppression system within a battery system is shown. For example, in the event of rise of pressure or temperature within a battery cell of a battery pack, reaction suppression may be employed in coordinating operation with actuation of a venting valve. Actuation of the venting valve may be responsive to an operating condition of the battery system or battery pack. The method may be at least partially implemented as executable instructions stored in controller memory in the system of FIGS. 1-3. Additionally, the method 500 may provide the operating sequence shown in FIG. 4.

At 502, method 500 determines battery pack operating condition(s). Battery pack operating conditions may be determined via the various sensors described herein. In one example the operating conditions may include but are not limited to, internal pressure within an enclosure of the battery pack and internal temperature within the enclosure of the battery pack. Method 500 then proceeds to 504.

At 504, method 500 judges the pressure differential between the internal environment within the enclosure and the external environment outside the enclosure, specifically judging if the internal pressure within the enclosure of the battery pack is equalized with the atmospheric pressure external to the enclosure of the battery pack. If method 500 judges that the internal pressure within the enclosure is not equalized with atmospheric pressure external to the enclosure (504 is NO), the method 500 proceeds to 508. Otherwise (504 is YES), the method 500 proceeds to 506. The internal pressure may be determined as unequal with the pressure external to the enclosure if the difference between the internal pressure and external pressure are greater than a non-zero threshold.

At 506, method 500 maintains the current operating conditions of the battery pack. Pressure being equalized between the atmosphere external to the enclosure and within the enclosure indicates normal operating conditions of the battery pack and does not indicate any need for a change in operation. Method 500 then proceeds back to 502.

At 508, method 500 equalizes the internal pressure within the enclosure with the atmospheric pressure external to the enclosure of the battery pack by venting gases into and out of the enclosure. The dual-staged venting valve may be coupled to the battery pack such that an internal environment (e.g., within the enclosure of the battery pack) is established on one side of the dual-staged venting valve and an external environment (e.g., outside the enclosure of the battery pack) is established on the opposite side of the dual-staged venting valve. The dual-staged venting valve, in the breathing state (e.g., the first stage of operation), may include a membrane to allow the passage of gases but to prevent passage of liquids and debris from entering the enclosure from the external environment.

At 510, the method 500 judges whether or not the rate of change of the pressure within the enclosure of the battery pack is above a set threshold rate of change. Alternatively, the method 500 may judge whether the pressure within the enclosure of the battery pack is above a preset threshold pressure or temperature, respectively. Sensors of a monitoring system of the battery pack may sense the pressure and temperature within the enclosure. A rapid rise in pressure or temperature within the enclosure of the battery packs may indicate a thermal event or exothermic reaction that may have been triggered by a short or fault in a battery cell within the enclosure or as a result of mechanical injury to a battery cell. As heat produced by the exothermic reaction increases, so does the pressure within the enclosure and the dual-staged venting valve in the breathing state, and the breathable membrane may not be able to properly equalize the pressure with the rapid rise in pressure/temperature.

If method 500 judges that the temperature or pressure within the enclosure of the battery pack above the threshold value (510 is YES), method 500 proceeds to 512. Otherwise (510 is NO), method 500 proceeds to 506. If method 500 proceeds to 506, method 500 continues current operating conditions of the battery pack and proceeds back to 502.

At 512, method 500 transitions the dual-staged venting valve from the breathing state to the open state (e.g., the second stage of operation) by actuating a first vent valve component of the dual-staged venting valve. The first vent valve may open in order to relieve pressure in the internal environment (e.g., within the battery pack). The first vent valve opening may relieve pressure by allowing a large volume of gas from the internal environment (e.g., within the battery pack) to escape to the external environment. Opening the first vent valve may also allow heat to escape the internal environment, thereby reducing the temperature of the internal environment. Relieving pressure and reducing the temperature of the internal environment may disrupt a positive feedback loop of a thermal event and may mitigate or slow the reaction. The method 500 then proceeds to 514.

At 514, the method 500 judges whether or not to release an SA into the enclosure of the battery pack based on the temperature within the enclosure as sensed by sensors of the monitoring system. If the temperature within the enclosure is above a preset threshold (514 is YES), the method 500 proceeds to 518. Otherwise (514 is NO), the method proceeds to 516.

At 516, the method 500 maintains the current operating condition and proceeds back to 514, where the method 500 again judges whether or not to release the SA. At 516, the dual-staged venting valve that was opened at 512 remains open.

At 518, the SA may be released into the enclosure of the battery pack. The SA may be housed within a housing that is located either inside the enclosure of the battery pack or outside the enclosure of the battery pack. When sensors of the monitoring system sense a rise in pressure or temperature, the dual-staged venting valve is actuated to open, as shown at 512, and a valve of the enclosure of the SA is actuated to open, as shown at 518, thereby releasing the SA into the enclosure of the battery pack. The SA may be an agent designed to terminate a chain reaction of an exothermic reaction, remove or limit oxidants within the battery pack, and/or reduce possibility of additional exothermic reactions. The SA may be a gas, liquid, or solid (e.g, a powder) agent. Dispensing the SA into the enclosure of the battery pack may slow or potentially stop the exothermic reaction causing the increased temperature and may remove any oxidants that may be present in the enclosure as a result of the reaction. Method 500 then proceeds to 520.

At 520, a solenoid coupled to the dual-staged venting valve may close (e.g., reseal) the dual-staged venting valve. The dual-staged venting valve had been opened at 506 in order to relieve pressure/temperature from within the internal environment. The solenoid may be triggered to close the dual-staged venting valve by the release of the SA into the enclosure.

Closing the dual-staged venting valve as the SA is being dispensed into the enclosure of the battery pack may keep the SA in the enclosure for a longer period of time than if the dual-staged venting valve were left open. Keeping the SA in the enclosure longer may reduce the possibility of additional exothermic reactions occurring within the battery pack. Battery cells that have experienced a fault or short causing a thermal event may reignite (e.g., experience additional exothermic reactions) up to days later if not adequately extinguished. The solenoid closing the dual-staged venting valve may keep the SA inside the enclosure for a period of time as long as or longer than the period of time when such additional reactions may occur. After 516, the method 500 proceeds to end.

The technical effect of the reaction suppression system and operating methods described herein is to reliably respond to a temperature or pressure rise within a battery enclosure in order to slow a reaction and reduce possibility of further reactions in order to decrease degradation of the battery pack. Reducing the pressure and temperature interrupts a positive feedback pathway of the exothermic reaction and allows for slowing of the thermal event. Administration of the SA limits or reduces oxidants within the battery enclosure to decrease degradation that such oxidants may cause to the battery pack or battery cells within the battery enclosure.

The disclosure also provides support for a method of operating a battery enclosure venting system, comprising, coordinating operation of a venting valve of a battery enclosure and delivery of a suppressing agent in the battery enclosure, based on pressure and/or temperature within the battery enclosure. In a first example of the method, coordinating operation includes venting the enclosure before delivery of the SA, and then sealing the enclosure at least for a duration after delivering the SA. In a second example of the method, optionally including the first example, the venting valve is a dual-staged venting valve which is actuated to transition from a first stage to a second stage based on pressure within the battery enclosure as sensed by a sensor of a monitoring system housed within the battery enclosure. In a third example of the method, optionally including one or both of the first and second examples, the first stage of the dual-staged venting valve comprises a breather vent to equalize pressure between an internal environment within the battery enclosure and an external environment outside the battery enclosure. In a fourth example of the method, optionally including one or more or each of the first through third examples, the second stage of the dual-staged venting valve comprises a vent valve that, when actuated, opens to allow unrestricted flow of gases out of the battery enclosure. In a fifth example of the method, optionally including one or more or each of the first through fourth examples, the method further comprises: determining pressure differential between an internal environment within the battery enclosure and an external environment, and equalizing pressure between the internal environment and external environment via a breather vent of the venting valve. In a sixth example of the method, optionally including one or more or each of the first through fifth examples, the method further comprises: actuating a vent valve of the venting valve when pressure or rate of change of pressure within an internal environment of the battery enclosure is determined to be higher than a preset threshold as sensed by a sensor. In a seventh example of the method, optionally including one or more or each of the first through sixth examples, the method further comprises: dispensing the SA from an SA housing into an internal environment within the enclosure when temperature within the battery enclosure rises to a preset threshold as sensed by a sensor of a monitoring system housed within the battery enclosure. In an eighth example of the method, optionally including one or more or each of the first through seventh examples, the method further comprises: sealing the venting valve via a solenoid following release of the SA into the battery enclosure. In a ninth example of the method, optionally including one or more or each of the first through eighth examples, the solenoid is triggered to seal the venting valve by release of the SA, thereby sealing off an interior of the battery enclosure from an external environment. The disclosure also provides support for a battery system for an electric vehicle, comprising: a battery pack, a suppressing agent (Sa), and a venting system including one or more valves configured to selectively vent and seal a battery enclosure responsive to an operating condition of the battery enclosure and operation of the Sa. In a first example of the system, the battery pack comprises a plurality of battery cells housed inside the battery enclosure. In a second example of the system, optionally including the first example, the SA is housed within an SA enclosure that is located either within an enclosure of the battery pack or outside the enclosure of the battery pack. In a third example of the system, optionally including one or both of the first and second examples, the suppressing agent is released into an enclosure of the battery pack during an increased temperature event. In a fourth example of the system, optionally including one or more or each of the first through third examples, the system further comprises: a monitoring system that includes at least one sensor. In a fifth example of the system, optionally including one or more or each of the first through fourth examples, the sensor of the monitoring system is configured to sense pressure and/or temperature within the battery enclosure of the battery system. The disclosure also provides support for a venting system for a battery enclosure of an electric vehicle, comprising: a dual-staged venting valve that comprises a breather vent and a vent valve, and a solenoid, wherein the dual-staged venting valve is positioned in fluid connection with the battery enclosure via a and the dual-staged venting valve fluidically couples an interior of the battery enclosure to an external environment. In a first example of the system, the dual-staged venting valve comprises a plurality of stages including a first stage wherein the breather vent equalizes pressure between an external environment and an internal environment within an enclosure of a battery pack, a second stage wherein the vent valve opens to relieve pressure within the enclosure by allowing unrestricted flow of gases out of the enclosure, and a third stage wherein the dual-staged venting valve is sealed via the solenoid. In a second example of the system, optionally including the first example, the breather vent comprises a breathable membrane configured to prevent debris and liquid from entering an interior of the battery enclosure from an external environment. In a third example of the system, optionally including one or both of the first and second examples, the vent valve is configured to open upon actuation from a sensor, wherein the sensor is configured to sense pressure and to actuate the vent valve when the pressure within the battery enclosure is above a preset threshold or when rate of change of pressure is above a preset threshold. In a fourth example of the system, optionally including one or more or each of the first through third examples, the system further comprises: a power supply independent from battery cells of a vehicle, wherein the venting system is powered by the power supply. In a fifth example of the system, optionally including one or more or each of the first through fourth examples, a circuit coupled to the power supply is configured to actuate the dual-staged venting valve.

It will be appreciated that the configurations and routines disclosed herein are exemplary in nature, and that these specific embodiments are not to be considered in a limiting sense, because numerous variations are possible. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method of operating a battery enclosure venting system, comprising;
coordinating operation of a venting valve of a battery enclosure and delivery of a suppressing agent (SA) in the battery enclosure, based on pressure and/or temperature within the battery enclosure.

2. The method of claim 1, wherein coordinating operation includes venting the battery enclosure before delivery of the SA, and then sealing the battery enclosure at least for a duration after delivering the SA.

3. The method of claim 1, wherein the venting valve is a dual-staged venting valve which is actuated to transition from a first stage to a second stage based on pressure within the battery enclosure as sensed by a sensor of a monitoring system housed within the battery enclosure.

4. The method of claim 3, wherein the first stage of the dual-staged venting valve comprises a breather vent to equalize pressure between an internal environment within the battery enclosure and an external environment outside the battery enclosure.

5. The method of claim 3, wherein the second stage of the dual-staged venting valve comprises a vent valve that, when actuated, opens to allow unrestricted flow of gases out of the battery enclosure.

6. The method of claim 1, further comprising;
determining pressure differential between an internal environment within the battery enclosure and an external environment; and
equalizing pressure between the internal environment and external environment via a breather vent of the venting valve.

7. The method of claim 1, further comprising;
actuating a vent valve of the venting valve when pressure or rate of change of pressure within an internal environment of the battery enclosure is determined to be higher than a preset threshold as sensed by a sensor.

8. The method of claim 1, further comprising;
dispensing the SA from an SA housing into an internal environment within the enclosure when temperature within the battery enclosure rises to a preset threshold as sensed by a sensor of a monitoring system housed within the battery enclosure.

9. The method of claim 1, further comprising sealing the venting valve via a solenoid following release of the SA into the battery enclosure.

10. The method of claim 9, wherein the solenoid is triggered to seal the venting valve by release of the SA, thereby sealing off an interior of the battery enclosure from an external environment.

11. A battery system for an electric vehicle, comprising:
a battery pack;
a suppressing agent (SA); and
a venting system including one or more valves configured to selectively vent and seal a battery enclosure responsive to an operating condition of the battery enclosure and operation of the SA.

12. The battery system of claim 11, wherein the battery pack comprises a plurality of battery cells housed inside the battery enclosure.

13. The battery system of claim 11, wherein the SA is housed within an SA enclosure that is located either within an enclosure of the battery pack or outside the enclosure of the battery pack.

14. The battery system of claim 11, wherein the suppressing agent is released into an enclosure of the battery pack during an increased temperature event.

15. The battery system of claim 11, further comprising a monitoring system that includes at least one sensor, wherein the sensor of the monitoring system is configured to sense pressure and/or temperature within the battery enclosure of the battery system.

16. A venting system for a battery enclosure of an electric vehicle, comprising:
a dual-staged venting valve that comprises a breather vent and a vent valve, and a solenoid, wherein the dual-staged venting valve is positioned in fluid connection with the battery enclosure and the dual-staged venting valve fluidically couples an interior of the battery enclosure to an external environment.

17. The venting system of claim 16, wherein the dual-staged venting valve comprises a plurality of stages including a first stage wherein the breather vent equalizes pressure between an external environment and an internal environment within an enclosure of a battery pack; a second stage wherein the vent valve opens to relieve pressure within the enclosure by allowing unrestricted flow of gases out of the enclosure; and a third stage wherein the dual-staged venting valve is sealed via the solenoid.

18. The venting system of claim 16, wherein the breather vent comprises a breathable membrane configured to prevent debris and liquid from entering an interior of the battery enclosure from an external environment.

19. The venting system of claim 16, wherein the vent valve is configured to open upon actuation from a sensor, wherein the sensor is configured to sense pressure and to actuate the vent valve when the pressure within the battery enclosure is above a preset threshold or when rate of change of pressure is above a preset threshold.

20. The venting system of claim 16 further comprising a power supply independent from battery cells of a vehicle, wherein the venting system is powered by the power supply, wherein a circuit coupled to the power supply is configured to actuate the dual-staged venting valve.
